(19) United States
(12) Patent Application Publication
(10) Pub. No.: US 2026/0289886 A1
(43) Pub. Date: Sep. 24, 2026

(54) ON-DEVICE ABSTRACT AVATAR CREATION AND REAL-TIME ANIMATION FOR EXTENDED REALITY (XR) OR OTHER EXPERIENCES

(71) Applicant: Samsung Electronics Co., Ltd., Suwon-si (KR)

(72) Inventors: Hong-Shuo Chen, San Jose, CA (US); Ritaban Roy, San Jose, CA (US); Siva Penke, San Jose, CA (US)

(21) Appl. No.: 19/360,811

(22) Filed: Oct. 16, 2025

Related U.S. Application Data
(60) Provisional application No. 63/774,012, filed on Mar. 18, 2025.

(51) Int. Cl. G06T 13/40; G06T 7/13; G06T 17/00; G06V 40/16

(52) U.S. Cl. CPC G06T 13/40; G06T 7/13; G06T 17/00; G06V 40/171; G06T 2207/30201

(57) ABSTRACT

A method includes receiving a user input image for a user and determining contour lines for the user input image using a first model performing edge detection. The method also includes determining facial features for the user input image using ellipse fitting to the contour lines and ellipse filtering to keep only specified ones of the facial features. The method further includes assigning landmark points for the user input image along ellipses remaining after the ellipse filtering. The method also includes receiving audio frames including speech data and, for each of the audio frames, using a second model to predict positions of the landmark points for the user input image based on audio features in the audio frame. In addition, the method includes generating an animated avatar by warping the landmark points for the user input image based on the predicted positions of the landmark points.

### CROSS-REFERENCE TO RELATED APPLICATION AND PRIORITY CLAIM

This application claims priority under 35 U.S.C. § 119(e) to U.S. Provisional Patent Application No. 63/774,012 filed on Mar. 18, 2025, which is hereby incorporated by reference in its entirety.

### TECHNICAL FIELD

This disclosure relates generally to animation systems and processes for avatars. More specifically, this disclosure relates to on-device abstract avatar creation and real-time animation for extended reality (XR) or other experiences.

### BACKGROUND

Real-time on-device avatars can be useful or important for enhancing immersive experiences in extended reality (XR) or other environments, enabling low-latency and privacy-preserving but highly-personalized interactions that can be valuable for social virtual reality (VR) interaction, gaming, smart device interfaces, or other applications. By processing avatars directly on devices, latency is reduced, ensuring smoother and more immediate interactions. Lightweight models optimized for edge devices maintain performance without requiring cloud processing.

### SUMMARY

This disclosure relates to on-device abstract avatar creation and real-time animation for extended reality (XR) or other experiences.

In a first embodiment, a method includes receiving a user input image for a user and determining contour lines for the user input image using a first model performing edge detection. The method also includes determining facial features for the user input image using ellipse fitting to the contour lines and ellipse filtering to keep only specified ones of the facial features. The method further includes assigning landmark points for the user input image along ellipses remaining after the ellipse filtering. The method also includes receiving audio frames including speech data and, for each of the audio frames, using a second model to predict positions of the landmark points for the user input image based on audio features in the audio frame. In addition, the method includes generating an animated avatar by warping the landmark points for the user input image based on the predicted positions of the landmark points.

In a second embodiment, an electronic device includes at least one processing device configured to receive a user input image for a user and determine contour lines for the user input image using a first model performing edge detection. The at least one processing device is also configured to determine facial features for the user input image using ellipse fitting to the contour lines and ellipse filtering to keep only specified ones of the facial features. The at least one processing device is further configured to assign landmark points for the user input image along ellipses remaining after the ellipse filtering. The at least one processing device is also configured to receive audio frames including speech data and, for each of the audio frames, use a second model to predict positions of the landmark points for the user input image based on audio features in the audio frame. In addition, the at least one processing device is configured to generate an animated avatar by warping the landmark points for the user input image based on the predicted positions of the landmark points.

In a third embodiment, a non-transitory machine readable medium contains instructions that when executed cause at least one processor of an electronic device to receive a user input image for a user and determine contour lines for the user input image using a first model performing edge detection. The instructions when executed also cause the at least one processor to determine facial features for the user input image using ellipse fitting to the contour lines and ellipse filtering to keep only specified ones of the facial features. The instructions when executed further cause the at least one processor to assign landmark points for the user input image along ellipses remaining after the ellipse filtering. The instructions when executed also cause the at least one processor to receive audio frames including speech data and, for each of the audio frames, use a second model to predict positions of the landmark points for the user input image based on audio features in the audio frame. In addition, the instructions when executed cause the at least one processor to generate an animated avatar by warping the landmark points for the user input image based on the predicted positions of the landmark points.

Any single one or any combination of the following features may be used with the first, second, or third embodiment.

The user input image may include one of: an emoji, a hand-drawn doodle from the user, a cartoon figure, or an object without facial features.

The user input image may include an object without facial features, and the user may select one or more animatable facial features to overlap on the object and to be animated. The one or more animatable facial features may include one or more of: eyes, a mouth, a nose, jaws, or eyebrows.

The animated avatar may be displayed for an application executing on at least one of: a mobile device, an XR device, or a smart display.

The facial features for the user input image may include at least eyes and a mouth, and the landmark points may be assigned from at least the eyes and the mouth.

The facial features for the user input image may be determined by fitting an initial set of ellipses according to the contour lines for the user input image. The initial set of ellipses may be filtered by (i) removing one or more of the ellipses that fit within another of the ellipses and (ii) removing one or more ellipses located within a specified region of the user input image and having a size exceeding a specified threshold.

The landmark points may be assigned by assigning the landmark points with an equal distance around the ellipses remaining after the ellipse filtering.

The animated avatar may be generated by, for each of the audio frames, determining a shape key corresponding to the predicted positions of the landmark points and using the shape key to warp the landmark points for the user input image.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have”, “may have”, “include”, or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B”, “at least one of A and B”, and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for”, “having the capacity to”, “designed to”, “adapted to”, “made to”, or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a”, “an”, and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism”, “module”, “device”, “unit”, “component”, “element”, “member”, “apparatus”, “machine”, “system”, “processor”, or “controller”, within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration that may be employed for on-device abstract avatar creation and real-time animation in accordance with this disclosure;

FIG. 2 illustrates an example process of on-device abstract avatar creation and real-time animation in accordance with this disclosure;

FIGS. 3A and 3B illustrate an example pipeline for on-device abstract avatar creation and real-time animation in accordance with this disclosure;

FIG. 4 illustrates an example creation process within the pipeline of FIGS. 3A and 3B in accordance with this disclosure;

FIGS. 5A-10B illustrate visualization examples of edge/contour detection within the creation process of FIG. 4 in accordance with this disclosure;

FIGS. 11A-12C illustrate visualization examples for contour extraction within the creation process of FIG. 4 in accordance with this disclosure;

FIGS. 13A-14B illustrate examples of ellipse fitting for the images of FIGS. 5A-6B in accordance with this disclosure;

FIGS. 15A-16C illustrate examples of filtering ellipses for the images of FIGS. 5A-6B in accordance with this disclosure;

FIG. 17 illustrates an example reference face template for landmark assignment within the creation process of FIG. 4 in accordance with this disclosure;

FIGS. 18A-19B illustrate examples of landmark assignment for a cartoon image of FIG. 6A and an overlay face of FIG. 3B in accordance with this disclosure;

FIGS. 20A and 20B illustrate examples of applying Delauney triangulation within the creation process of FIG. 4 in accordance with this disclosure;

FIG. 21 graphically illustrates the principle of Delauney triangulation in accordance with this disclosure;

FIG. 22 illustrates an example animation process within the pipeline of FIGS. 3A and 3B in accordance with this disclosure;

FIGS. 23 and 24 illustrate example processes for implementing an audio-to-landmarks model for the avatar animation process of FIG. 22 in accordance with this disclosure;

FIGS. 25A and 25B illustrate an example of landmarks normalization during the avatar animation process of FIG. 22 in accordance with this disclosure;

FIG. 26 illustrates an example affine transform of landmarks and anchor points at edges of an image during the avatar animation process of FIG. 22 in accordance with this disclosure;

FIGS. 27A-28B illustrate example animations of a foreground only and a complete image during the avatar animation process of FIG. 22 in accordance with this disclosure;

FIGS. 29A and 29B illustrate an example correlation of mouth movement and changes to a jawline during the complete image animation within the avatar animation process of FIG. 22 in accordance with this disclosure; and

FIGS. 30A-31 illustrate example use cases for on-device abstract avatar creation and real-time animation in accordance with this disclosure.

### DETAILED DESCRIPTION

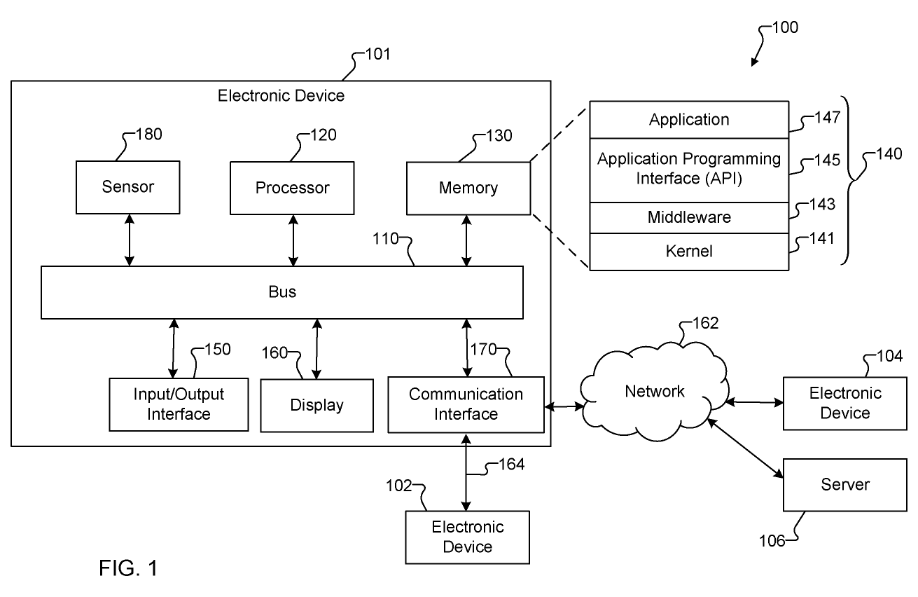

FIGS. 1-31, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, real-time on-device avatars can be useful or important for enhancing immersive experiences in extended reality (XR) or other environments, enabling low-latency and privacy-preserving but highly-personalized interactions that can be valuable for social virtual reality (VR) interaction, gaming, smart device interfaces, or other applications. By processing avatars directly on devices, latency is reduced, ensuring smoother and more immediate interactions. Lightweight models optimized for edge devices maintain performance without requiring cloud processing.

This disclosure relates to abstract avatars that offer creative expression and allow users to convey emotions and presence in new ways, enriching the interactivity and engagement in both virtual and connected physical spaces. For example, on-device abstract avatar creation can be performed on an emoji, a hand-drawn doodle, a cartoon figure, or any other object with or without facial features (such as a mug). Real-time animation of the abstract avatar can be provided, such as through an audio-to-landmarks model. The resulting virtual abstract avatar may be employed, for example, with XR glasses or other devices as a virtual assistant.

In this way, a real-time on-device framework can be used for creating an abstract avatar, such as on a mobile or XR device, and for animating the avatar using audio, text, camera, or other inputs. In some cases, any suitable image may be converted into an abstract avatar on-device, such as with image processing and machine learning techniques. Also, in some cases, the abstract avatar may be animated using XR glasses or other device as a virtual assistant, presented on a smart display or other device where a user can perceive the avatar, or presented on a mobile device to communicate with (for example) appliances.

Among other features, abstract avatars can be generated in real-time. A received user input image, such as an emoji, a hand-drawn doodle, a cartoon figure, or any other object (such as a mug or a clock) without facial features may be utilized. Contour lines for the user input image can be determined using a first edge detection model. An understanding of the facial features can be obtained with fitting and filtering of ellipses corresponding to the contour lines and assigning facial landmark points along the fitted ellipses. Audio frames including speech data can be received and, for each audio frame, a second model can be used to predict positions of landmark points based on audio features in the audio frame. Animation of an avatar can be generated by warping the facial landmark points on the user input image according to the predicted positions.

Here, understanding of avatar facial motion can be obtained by fitting ellipses according to detected contours from the user input image, where the ellipses can be utilized to fit the avatar facial features and filtered by removing one or more ellipses that either fit within another ellipse or are located within a predetermined region of the user image with abnormal size using a predefined filtering threshold. Facial landmarks can be assigned around the ellipses with an equal distance. Animation of the avatar can be generated by, for each audio frame, determining a shape key corresponding to the predicted landmark points and using the shape key to warp the landmark points on the user input image.

FIG. 1 illustrates an example network configuration 100 that may be employed for on-device abstract avatar creation and real-time animation in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described in more detail below, the processor 120 may perform various operations related to on-device abstract avatar creation and real-time animation.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to on-device abstract avatar creation and real-time animation. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, Wi-Fi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as a head mounted display (or “HMD”)). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network. The electronic device 101 can also be an extended reality (XR) device, which includes a virtual reality (VR) headset or an augmented reality (AR) wearable device, such as eyeglasses that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of the operations (or functions) implemented on the electronic device 101. For example, the server 106 can include a processing module or processor that may support the processor 120 implemented in the electronic device 101. As described in more detail below, the server 106 may perform various operations related to on-device abstract avatar creation and real-time animation.

Although FIG. 1 illustrates one example of a network configuration 100 that may be employed for on-device abstract avatar creation and real-time animation, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

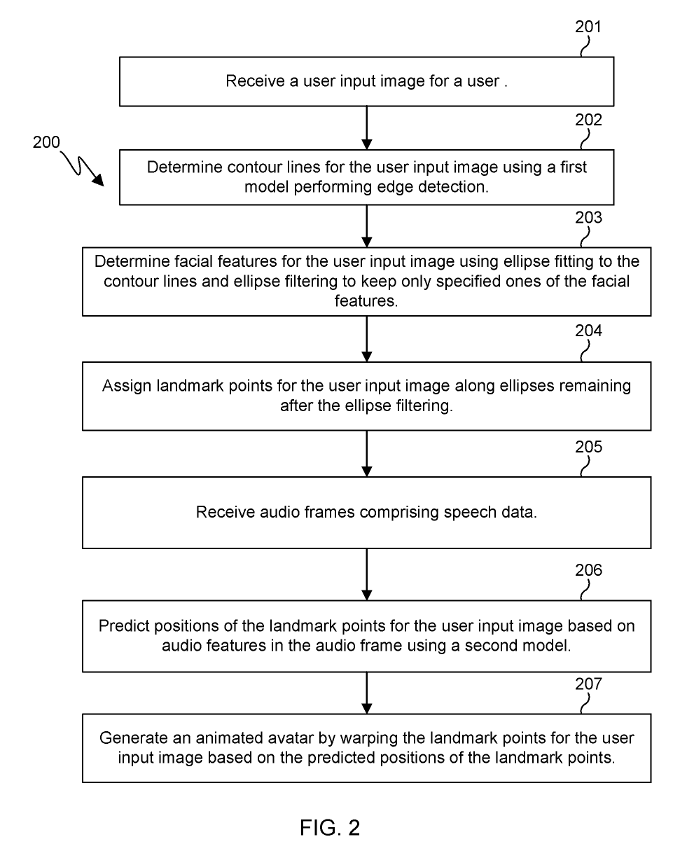

FIG. 2 illustrates an example process 200 of on-device abstract avatar creation and real-time animation in accordance with this disclosure. For ease of explanation, the process 200 of FIG. 2 is described as being performed using the electronic device 101 in the network configuration 100 of FIG. 1. However, the process 200 may be performed using any other suitable device(s) (such as the server 106) and in any other suitable system(s).

As shown in FIG. 2, the process 200 begins with receiving a user input image for a user (step 201). In some cases, the user input image may be an emoji, a hand-drawn doodle from the user, a cartoon figure, or an object without facial features. For an object without facial features, the user may select one or more animatable facial features to overlap on the object and to be animated. For instance, the one or more animatable facial features may include at least eyes and a mouth and optionally one or more of a nose, jaws, or eyebrows.

Contour lines for the user input image are determined using a first model performing edge detection (step 202). The contour lines may correspond to facial features important to animation, such as eyes and a mouth and optionally eyebrows or a jawline. Facial features for the user input image are determined using ellipse fitting to the contour lines and ellipse filtering to keep only specified ones of the facial features (step 203). For example, an initial set of ellipses may be fitted according to the contour lines for the user input image. An ellipse entirely contained within another ellipse may be filtered as being unnecessary for animation. Also or alternatively, ellipses located within a specified region of the user input image and having a size exceeding a specified threshold may be removed.

Landmark points for the user input image are assigned along ellipses remaining after the ellipse filtering (step 204). In some cases, the landmark points may be assigned with an equal distance around the ellipses remaining after the ellipse filtering. Landmark points can be assigned from at least the eyes and the mouth among the facial features demarcated by ellipses. An animatable abstract avatar image can be created by the previous steps and may be animated by the steps described below.

Audio frames including speech data are received (step 205). For example, the audio frames may include speech from a user, an output of text-to-speech for text from a virtual assistant or entered by the user, or extracted from live video of a user’s face. For each of the audio frames, a second model is used to predict positions of the landmark points for the user input image based on audio features in the audio frame (step 206). In some cases, the predicted landmark point positions can be normalized, such as based on the avatar image size.

An animated avatar is generated by warping the landmark points for the user input image based on the predicted positions of the landmark points (step 207). For example, a mesh of the predicted landmark points can be warped for each audio frame from one to the next. As a particular example, for each of the audio frames, a shape key corresponding to the predicted positions of the landmark points may be determined and used to warp the landmark points for the user input image. Once warping is complete, the animated avatar may be used in any suitable manner, such as when displayed for an application executing on at least one of a mobile device, an XR device, or a smart display.

Although FIG. 2 illustrates one example of a process 200 of on-device abstract avatar creation and real-time animation, various changes may be made to FIG. 2. For example, while shown as a series of steps, various steps in FIG. 2 could overlap, occur in parallel, occur in a different order, or occur any number of times (including zero times).

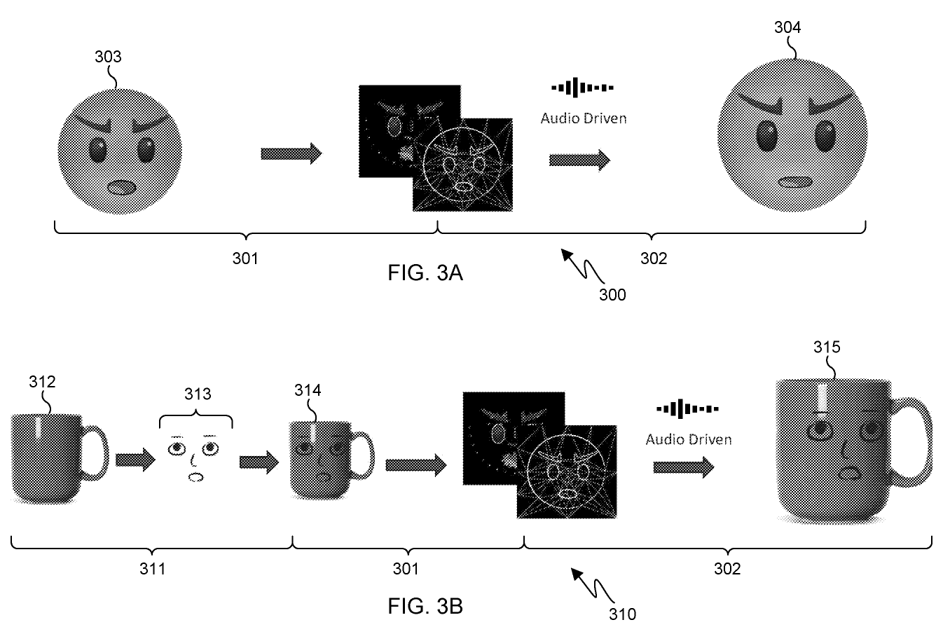

FIGS. 3A and 3B illustrate an example pipeline 300, 310 for on-device abstract avatar creation and real-time animation in accordance with this disclosure. For ease of explanation, the pipeline 300, 310 of FIGS. 3A and 3B is described as being implemented within the electronic device 101 in the network configuration 100 of FIG. 1, which can be configured to perform the process 200 of FIG. 2. However, the pipeline 300, 310 may be implemented using any other suitable device(s) and in any other suitable system(s) and process(es).

As shown in FIGS. 3A and 3B, the pipeline 300, 310 includes two general processes: a creation process 301 and an audio-driven animation process 302. For example, given an emoji image 303 or other input (such as a hand-drawn doodle, a cartoon figure, or any other object) as shown in FIG. 3A, the pipeline 300 creates an audio-driven avatar 304. For static images with facial features such as an emoji or other input, the image can be converted into an animatable abstract avatar as shown in FIG. 3A for an “angry” emoji image 303. For static images of an object 312 (such as a mug in the case of FIG. 3B) that does not have a defined “face,” the same creation process 301 and audio-driven animation process 302 may be employed as augmented by a face creation process 311. The face creation process 311 allows a user to select among predefined sets of facial features or to create a hand-drawn doodle as the face 313 for overlay on the object 312, allowing for the creation of an image 314 of the object with facial features. The image 314 of the object with facial features undergoes the audio-driven animation process 302 to create and audio-driven avatar 315.

Although FIGS. 3A and 3B illustrate one example of a pipeline 300, 310 for on-device abstract avatar creation and real-time animation, various changes may be made to FIGS. 3A and 3B. For example, while shown as separate processes for avatar creation and audio-driven animation, the processes 301, 302 (as well as process 311) may be integrated into a single continuous process, may each be subdivided into component process(es), or may have other process(es) interspersed therein or therebetween.

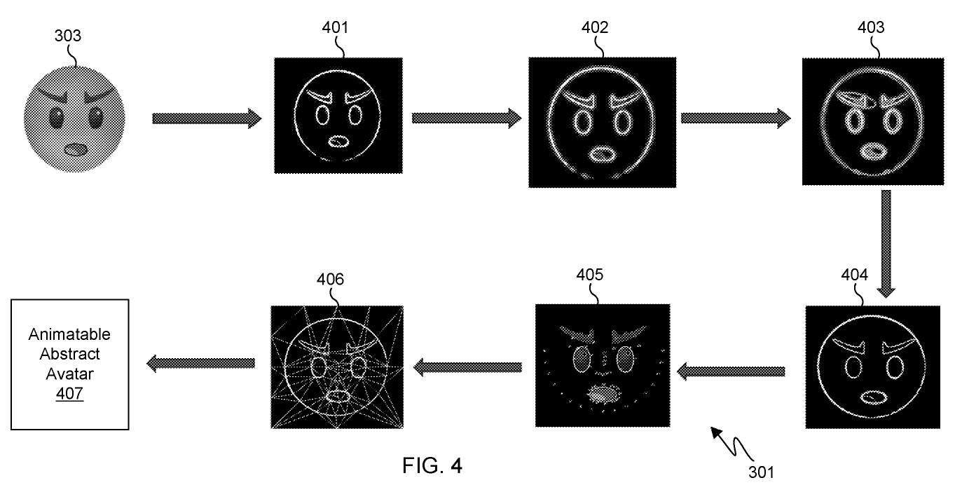

FIG. 4 illustrates an example creation process 301 within the pipeline 300, 310 of FIGS. 3A and 3B in accordance with this disclosure. For ease of explanation, the creation process 301 is described as being implemented within the electronic device 101 in the network configuration 100 of FIG. 1, which can be configured to perform the process 200 of FIG. 2. However, the creation process 301 may be implemented using any other suitable device(s) and in any other suitable system(s) and process(es).

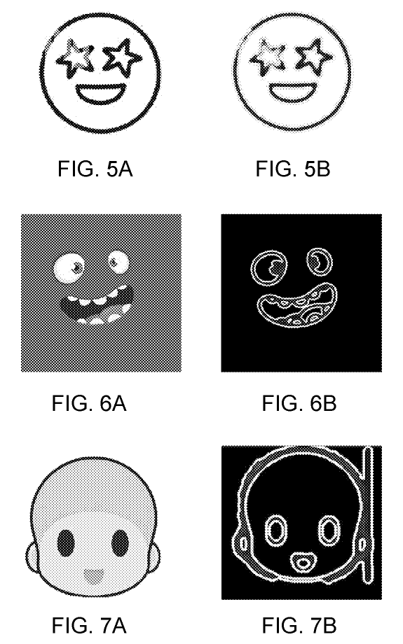

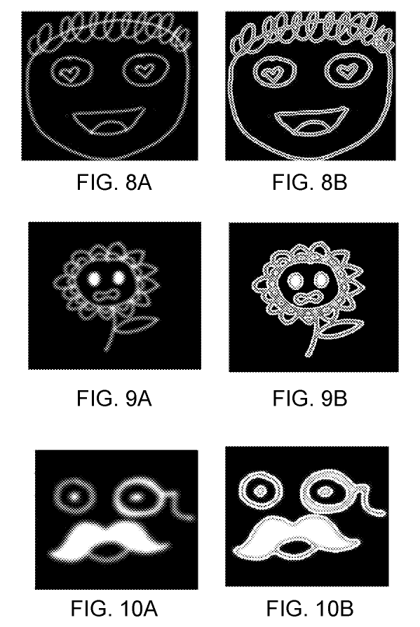

As described above in connection with FIG. 3A, the input image to the creation process 301 may be any image with facial attributes, such as an emoji image, a doodle, or a cartoon. In FIG. 4, the angry emoji image 303 is employed to demonstrate the creation process 301 step-by-step in detail. Binary or other edge detection can be performed on the emoji image 303 to extract a set 401 of important edges, which could include potential face contours, from the emoji image 303. An edge detection algorithm, such as one implemented using a lightweight edge detection convolutional neural network (CNN), may be used to perform the edge detection. Other visualization examples of edge/contour detection for different types of inputs are shown in FIGS. 5A-10B. More specifically, FIGS. 5A and 5B illustrate edge/contour detection for another emoji, FIGS. 6A-7B illustrate edge/contour detection for different cartoons, and FIGS. 8A-10B illustrate edge/contour detection for assorted hand-drawn doodles.

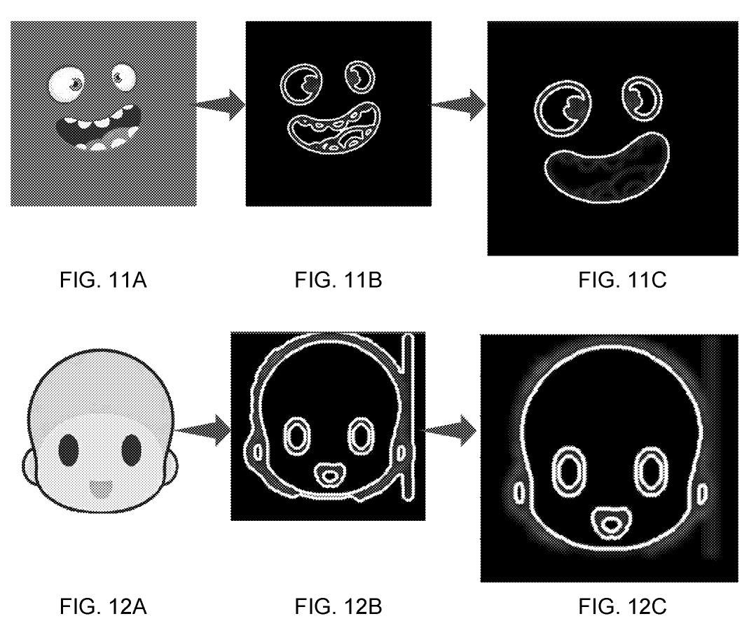

Referring back to FIG. 4, from the set 401 of edges, facial contours 402 can be extracted. Facial contours can be any shape and may include some detailed contours. Using these contours can help to better fit an ellipse in subsequent steps and locate a position of each facial landmark. FIGS. 11A-12C illustrate visualization examples for contour extraction. More specifically, FIGS. 11A-11C correspond to the cartoon of FIGS. 6A and 6B, and FIGS. 12A-12C correspond to the cartoon of FIGS. 7A and 7B. FIGS. 11B and 12B illustrate contour extraction from the images of FIGS. 11A and 12A, respectively. In some cases, contour properties may be employed to filter out some of the contours, such as is shown in FIGS. 11C and 12C, in which some contour lines in FIGS. 11B and 12B have been filtered. Example contour properties that may be used for filtering could include solidity (the ratio of contour area to the convex hull area of the contour) and aspect ratio (the ratio of width to height of a bounding rectangle of the contour).

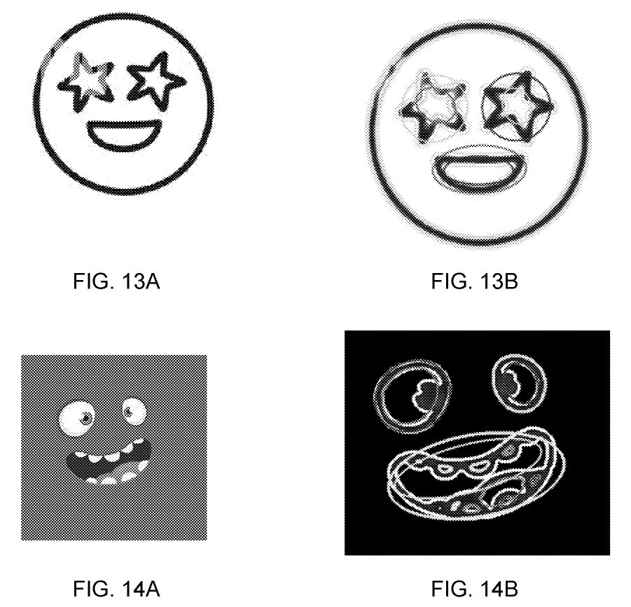

Again referring to FIG. 4, after extracting the contours 402, fitted ellipses 403 can be fitted to those contours. For example, at least one ellipse can be utilized to determine the positions of two eyes, eyebrows, mouth, and a jawline. FIGS. 13A-14B illustrate examples of ellipse fitting for the images of FIGS. 5A-6B. Ellipses can be fitted around the extracted and filtered contours. The ellipse fitting process can help to simplify the entire input image and help obtain useful or important facial key points.

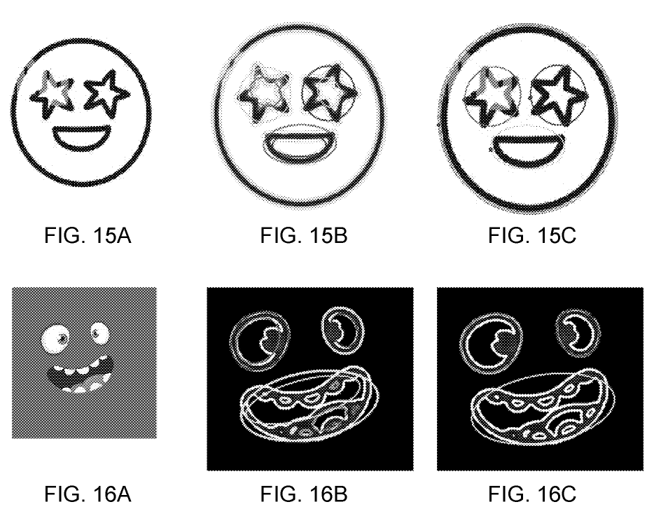

Filtered “clean” ellipses 404 are determined by filtering out unnecessary facial ellipses, such as by keeping only the mouth, eyes, and jawline. FIGS. 15A-16C illustrate examples of filtering ellipses for the images of FIGS. 5A-6B. FIGS. 15A and 16A correspond to the original image, FIGS. 15B and 16B illustrate all ellipses for contours detected in the images, and FIGS. 15C and 16C illustrate filtered ellipses. One or more ellipse properties may be used for filtering, such as when smaller ellipses contained within larger ellipses are eliminated and location-based filtering is employed to eliminate ellipses on the upper two-thirds or other portion of an image that has a wide aspect ratio.

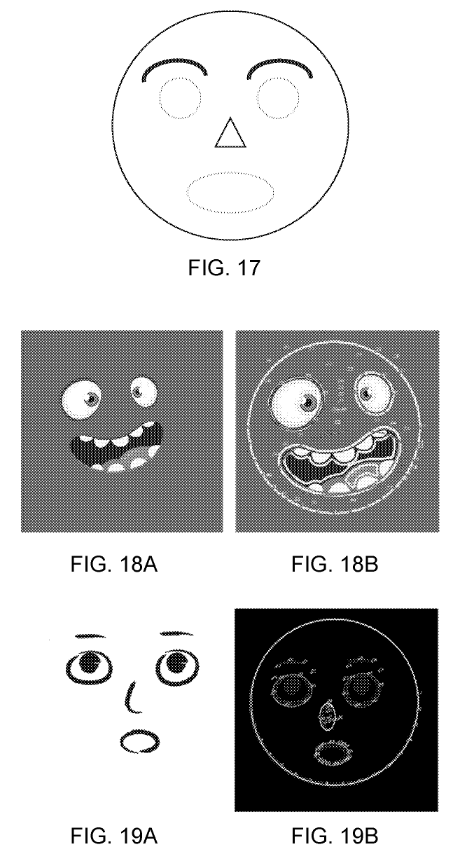

As shown in FIG. 4, a set of landmarks 405 can be assigned along the clean ellipses 404. For example, sixty-eight landmarks are shown in FIG. 4 along the ellipses determined for the emoji image 303. FIG. 17 illustrates an example reference face template for landmark assignment within the creation process of FIG. 4. In some cases, the eyes and mouth are the most critical parts or are otherwise useful or important for animation. In some cases, once landmarks for the eyes and the mouth are assigned, landmarks for a nose and eyebrows may be assigned with respect to the eyes and mouth. Since the nose is a relatively static facial feature that does not move much during speech, the actual nose location may not be particularly important. The eyebrows of a character may be of any shape and may be assigned (for example) based on eyebrow landmarks assigned along an arch following the eye according to the face template of FIG. 17. FIGS. 18A-19B illustrate examples of landmark assignment for the cartoon image of FIG. 6A and the overlay face of FIG. 3B. In some cases, landmark assignment may utilize a bounding box centered between the eyes and the mouth to place the nose if not present. However, even when the nose is present, the nose may optionally be ignored, and landmarks may be placed based only on the eyes and mouth. Also, in some cases, eyebrow landmarks may be assigned at an offset determined by eye size and generally follow a flatter arch than the eyes.

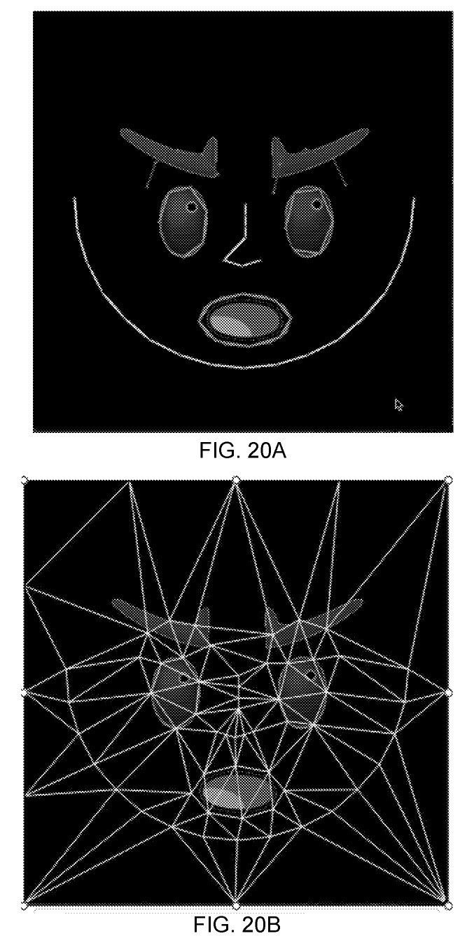

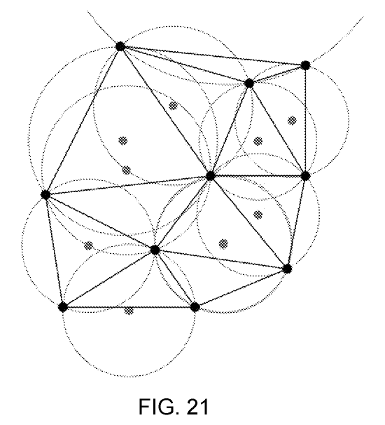

In some embodiments, Delauney triangulation 406 may be employed on the set of landmarks 405 to create a mesh 407 for an animatable abstract avatar. FIGS. 20A and 20B illustrate examples of applying Delauney triangulation within the creation process of FIG. 4, and FIG. 21 graphically illustrates the principle of Delauney triangulation. With Delauney triangulation, for a given set P of discrete points in a plane (such as a plane containing the assigned landmarks), a Delaunay triangulation function DT(P) is a triangulation such that no point in P is inside the circumcircle of any triangle in DT(P) as illustrated in FIG. 21. In FIG. 21, the vertices of any triangle could be used for animation, while the points inside of the demarcated triangles may not be utilized. FIG. 20A illustrates a face with eyes, mouth, nose, eyebrows, and jawline with assigned landmarks indicated. FIG. 20B is a counterpart to FIG. 20A illustrating the triangles defining which landmarks are selected for use during animation.

Although FIG. 4 illustrates one example of a creation process 301 within a pipeline for on-device abstract avatar creation and real-time animation and FIGS. 5A-21 illustrate related details, various changes may be made to FIGS. 4-21. For example, while shown as separate steps for avatar creation, ellipse fitting and filtering may be performed as a single step, or landmark assignment and Delauney triangulation may be integrally performed.

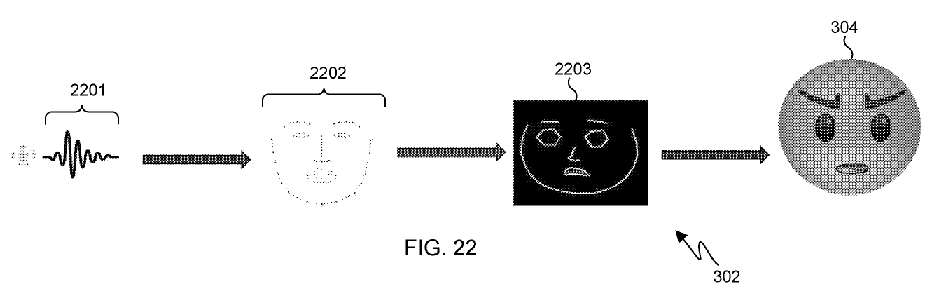

FIG. 22 illustrates an example animation process 302 within the pipeline of FIGS. 3A and 3B in accordance with this disclosure. For ease of explanation, the animation process 302 is described as being implemented within the electronic device 101 in the network configuration 100 of FIG. 1, which can be configured to perform the process 200 of FIG. 2 (with model training described below performed on the server 106). However, the animation process 302 may be implemented using any other suitable device(s) and in any other suitable system(s) and process(es).

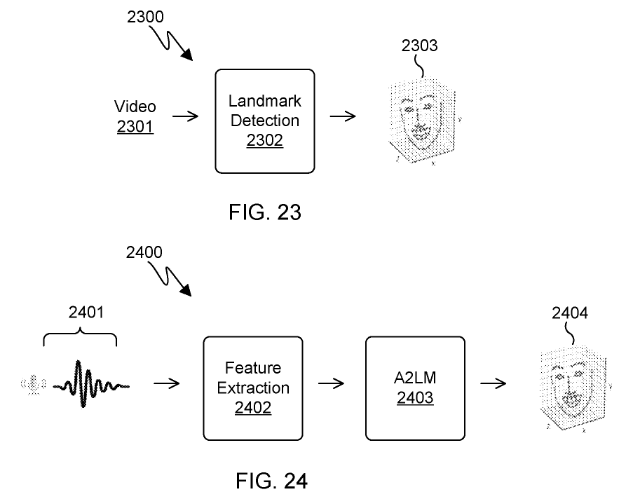

In FIG. 22, input audio 2201 collected by (for example) a microphone is used with a pretrained audio-to-landmarks model (A2LM) operating on landmarks 2202 to estimate predicted landmark movement for the input audio 2201. In some cases, the A2LM may be designed to output landmark motion driving avatar animation. FIGS. 23 and 24 illustrate example processes for implementing an audio-to-landmarks model for the avatar animation process of FIG. 22. More specifically, FIG. 23 illustrates an example data collection 2300 for use in training an A2LM model. For purposes of data collection 2300, talking head videos 2301 may be gathered, such as from one or more public sources, and analyzed by a landmarks detection 2302 algorithm or model (such as a CNN) to predict an alignment of landmarks and landmark motion for given audio features within the videos 2301. The dataset of videos 2301 may include, for example, hundreds of hours of video of talking heads or more.

FIG. 24 illustrates an example training and inference pipeline 2400 for an A2LM model. Input audio 2401 is processed by feature extraction 2402. In some cases, the model for feature extraction 2402 may be a large feature extraction model, such as a Hidden-Unit Bidirectional Encoder Representations from Transformers (HuBERT) model, or a small feature extraction model, to extract Mel-Frequency Cepstral Coefficients (MFCC) features or other features. The features extracted from the input audio 2401 by the feature extraction 2402 may be used by A2LM 2403. A2LM 2403 may be, for example, a variational autoencoder model that converts features of the input audio 2401 to predicted motion of landmarks 2404.

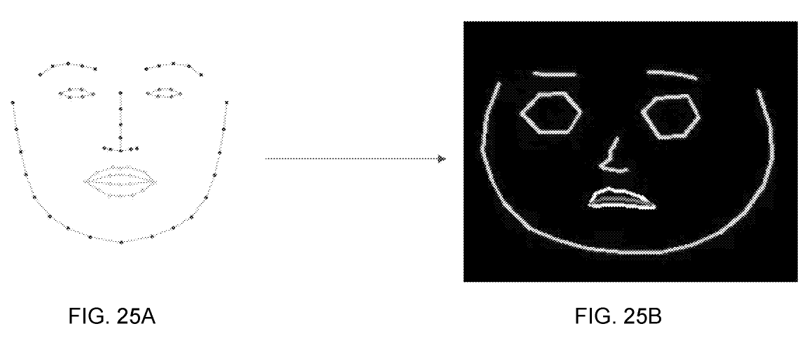

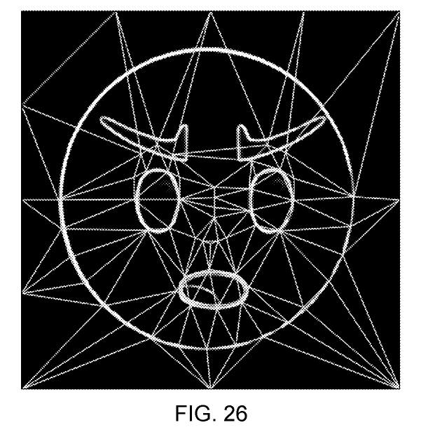

Referring back to FIG. 22, following A2LM operation on the landmarks 2202 to predict motion of those landmarks, normalization 2203 of the predicted landmark positions may be performed. This normalization, during the animation process, could include warping the mesh defined by the landmarks, rescaling the predicted landmarks to fit a space of the input image 303. FIGS. 25A and 25B illustrate an example of landmarks normalization during the avatar animation process of FIG. 22. Predicted landmarks, such as those depicted in FIG. 25A, are in a general space that fits most human faces. However, an abstract avatar may have a completely different face shape. Therefore, the ratio of movements for each facial landmark keypoint can be adjusted appropriately to achieve a more natural facial movement via the normalized landmarks depicted in FIG. 25B. In some cases, normalization can utilize the location of each landmark point and the aspect ratios of the face size, mouth size, and the eye size. For example, if the abstract avatar contains a larger mouth shape, the mouth movement may need to be adjusted to make sure that the mouth movement is larger to match the face shape. As noted, animation can involve warping, which may occur through affine transform of the landmarks and anchor points at edges of the image (as shown in FIG. 26) between consecutive frames.

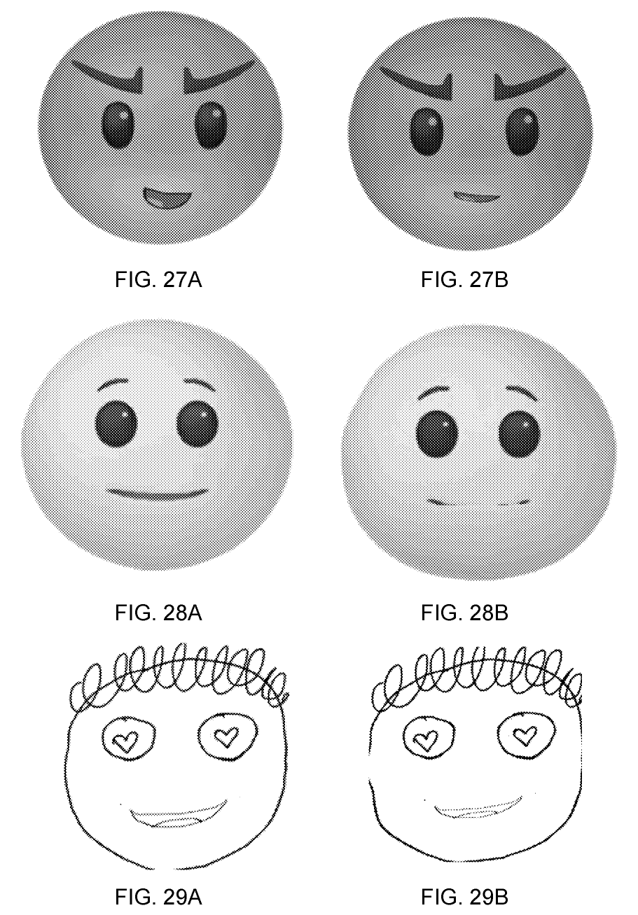

Referring once again to FIG. 22, a final output of the animation process 302 is an animated abstract avatar 304. For example, the animated abstract avatar may be animated so as to appear as if talking and communicating with one or more users. Animation may encompass the entire image or may be limited to the foreground while keeping the background static. FIGS. 27A-28B illustrate example animations of a foreground only and a complete image during the avatar animation process of FIG. 22. As apparent, the overall shape of the emoji in FIGS. 27A and 27B remains the same despite changes to the shape of the mouth. By contrast, for the emoji in FIGS. 28A and 28B, mouth movement causes changes in the shape of the “cheeks” or jawline, which manifests in the perimeter of the emoji image. FIGS. 29A and 29B illustrate an example correlation of mouth movement and changes to a jawline during the complete image animation within the avatar animation process of FIG. 22.

Although FIG. 22 illustrates one example of an animation process 302 for on-device abstract avatar creation and real-time animation and FIGS. 23-29B illustrate related details, various changes may be made to FIGS. 22-29B. For example, while shown as a series of sequential processes, the processes described may be performed in a pipelined manner for different frames within the animation.

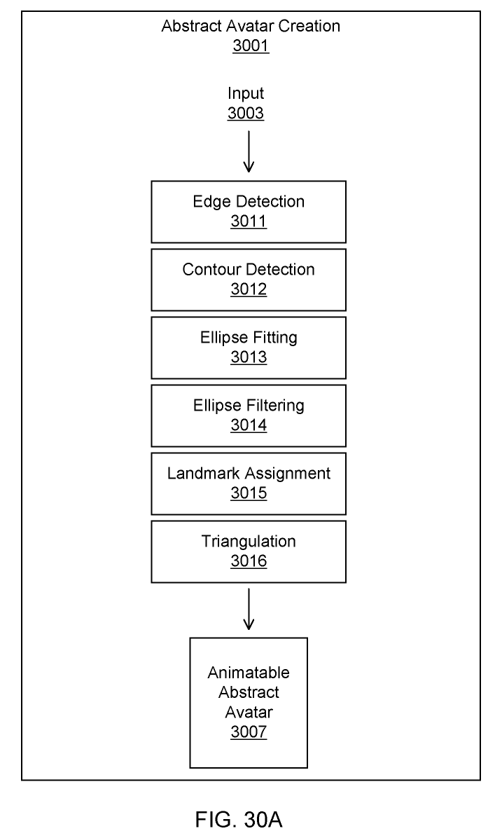

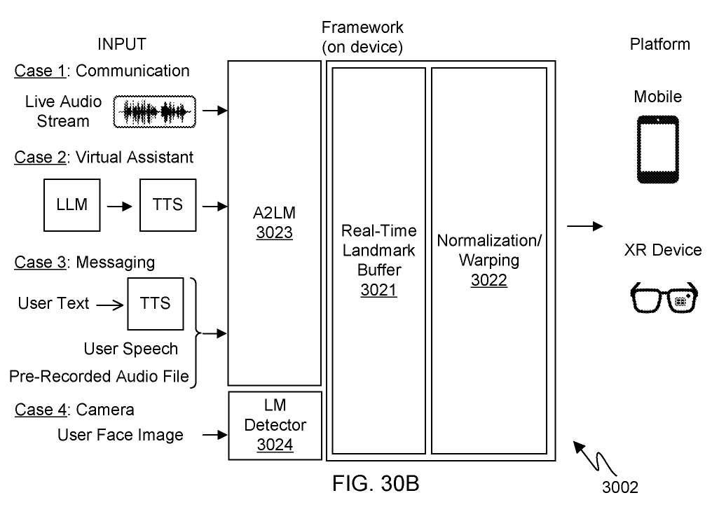

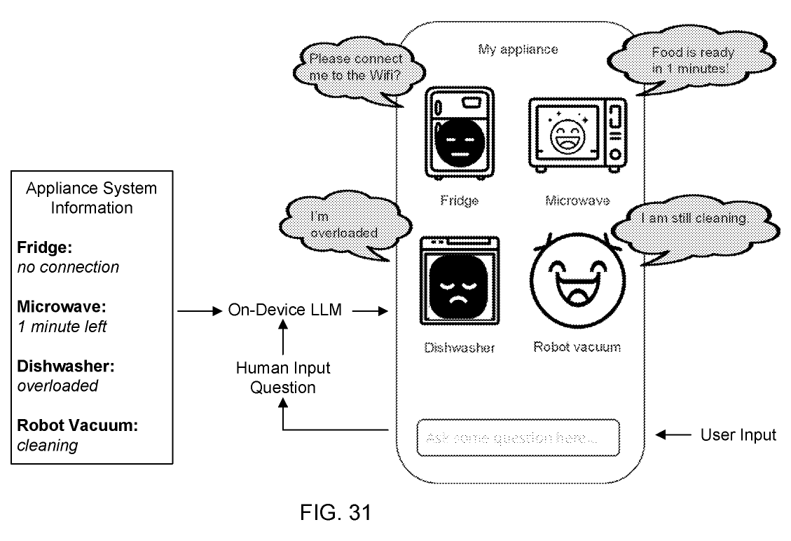

FIGS. 30A-31 illustrate example use cases for on-device abstract avatar creation and real-time animation in accordance with this disclosure. For ease of explanation, the use cases of FIGS. 30A-31 are described as being implemented using the pipeline 300, 310 shown in FIGS. 3A and 3B for use with the electronic device 101 in the network configuration 100 of FIG. 1, which could operate in collaboration with the server 106. However, the use cases illustrated in FIGS. 30A-31 may be implemented using any other suitable architecture(s) in any suitable device(s) and/or suitable system(s). Also, the pipeline 300, 310 may be used with other use cases.

FIG. 30A illustrates abstract avatar creation 3001, which can be analogous to the creation process 301 in FIGS. 3A and 3B. An input image 3003 (which could be comparable to the emoji image 303 or an image 314 of the object with facial features) is obtained. The input image 3003 may be an emoji, a hand drawn doodle, a cartoon, or an object image to which facial features have been added. The input image bundergoes edge detection 3011 to identify important or other edges that may correspond to contours (such as a set 401 of edges).

Contour detection 3012 uses the identified edges to determine facial contours (such as facial contours 402), some of which may be filtered as described above. Ellipse fitting 3013 and ellipse filtering 3014 are performed to determine ellipses (such as fitted ellipses 403 and clean ellipses 404) for at least the eyes and mouth. Landmark assignment 3015 assigns landmarks (such as a set of landmarks 405) along the ellipses, and triangulation 3016 (such as Delauney triangulation 406) creates a mesh, resulting in an animatable abstract avatar 3007. FIG. 30A is largely independent of the various use cases, except as to a need to add facial features. However, abstract avatar creation 3001 enables animation of the animatable abstract avatar 3007.

FIG. 30B illustrates abstract avatar animation 3002, which can be analogous to the animation process 302 in FIGS. 3A and 3B. Different inputs to which animation may be coordinated can be received for different use cases. For example, Case 1 in FIG. 30B involves communication by a user with another person for which a live audio stream is received. In Case 1, a virtual assistant may include an artificial intelligence (AI) model or service (such as BIXBY or a large language model), where the virtual assistant is represented to the user by an animated abstract avatar. Case 2 involves a virtual assistant that outputs a text-based communication converted to audio by a text-to-speech (TTS) function. Case 3 involves messaging for which an input may be user text that is converted to audio by a TTS function, user speech, or a pre-recorded audio file. In Case 3, the output may be a video message shared with friends or social media in which the user is rendered as an animated abstract avatar. Case 4 involves input from a camera for which an input may be a video of a user’s face from which audio may be extracted and/or a still image for creation of an avatar cartoon.

The on-device framework in FIG. 30B includes A2LM 3023 and optionally a language model (LM)-based detector 3024 for capturing audio and facial characteristics or movements. Outputs of the A2LM 2023 and optionally the LM-based detector 3024 can be used to update a real-time landmark buffer 3021, and normalization/warping 3022 can be performed on the contents of the real-time landmark buffer 3021 to render the animated avatar. The animated avatar may be output to various platforms, such as a mobile device or an XR device.

FIG. 31 illustrates a specific example of Case 2 in FIG. 30B in which the animated abstract avatar is employed for communication with one or more Internet-of-Things (IoT) devices such as a refrigerator, microwave, dishwasher, or robot vacuum. In a user interface display on a mobile device, a user may type, enter through speech-to-text, or otherwise provide a question, such as “How do I use my robot vacuum?” or “What is the current temperature of the refrigerator?” The user input is forwarded as text to an on-device LLM, which accesses relevant information (such as appliance status in the example of FIG. 31) and provides an animated abstract avatar conveying answers to the user upon actuation (such as by touching the representative icon) by the user. In this manner, the user can communicate with “smart” appliances to learn status or how to control the appliance.

Although FIGS. 30A-31 illustrate examples of use cases for on-device abstract avatar creation and real-time animation, various changes may be made to FIGS. 30A-31. For example, the functionality for abstract avatar creation and animation may be shared across the various use cases or used in any other suitable manner.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompasses such changes and modifications as fall within the scope of the appended claims.

What is claimed is:

1. A method comprising:
receiving a user input image for a user;
determining contour lines for the user input image using a first model performing edge detection;
determining facial features for the user input image using ellipse fitting to the contour lines and ellipse filtering to keep only specified ones of the facial features;
assigning landmark points for the user input image along ellipses remaining after the ellipse filtering;
receiving audio frames comprising speech data;
for each of the audio frames, using a second model to predict positions of the landmark points for the user input image based on audio features in the audio frame; and
generating an animated avatar by warping the landmark points for the user input image based on the predicted positions of the landmark points.

2. The method of claim 1, wherein the user input image comprises one of: an emoji, a hand-drawn doodle from the user, a cartoon figure, or an object without facial features.

3. The method of claim 1, wherein:
the user input image comprises an object without facial features;
the user selects one or more animatable facial features to overlap on the object and to be animated; and
the one or more animatable facial features comprise one or more of: eyes, a mouth, a nose, jaws, or eyebrows.

4. The method of claim 1, wherein the animated avatar is displayed for an application executing on at least one of: a mobile device, an extended reality (XR) device, or a smart display.

5. The method of claim 1, wherein:
the facial features for the user input image comprise at least eyes and a mouth; and
the landmark points are assigned from at least the eyes and the mouth.

6. The method of claim 1, wherein determining the facial features for the user input image comprises:
fitting an initial set of ellipses according to the contour lines for the user input image; and
filtering the initial set of ellipses by (i) removing one or more of the ellipses that fit within another of the ellipses and (ii) removing one or more ellipses located within a specified region of the user input image and having a size exceeding a specified threshold.

7. The method of claim 1, wherein assigning the landmark points comprises assigning the landmark points with an equal distance around the ellipses remaining after the ellipse filtering.

8. The method of claim 1, wherein generating the animated avatar comprises:
for each of the audio frames, determining a shape key corresponding to the predicted positions of the landmark points; and
using the shape key to warp the landmark points for the user input image.

9. An electronic device comprising:
at least one processing device configured to:
receive a user input image for a user;
determine contour lines for the user input image using a first model performing edge detection;
determine facial features for the user input image using ellipse fitting to the contour lines and ellipse filtering to keep only specified ones of the facial features;
assign landmark points for the user input image along ellipses remaining after the ellipse filtering;
receive audio frames comprising speech data;
for each of the audio frames, use a second model to predict positions of the landmark points for the user input image based on audio features in the audio frame; and
generate an animated avatar by warping the landmark points for the user input image based on the predicted positions of the landmark points.

10. The electronic device of claim 9, wherein the user input image comprises one of: an emoji, a hand-drawn doodle from the user, a cartoon figure, or an object without facial features.

11. The electronic device of claim 9, wherein:
the user input image comprises an object without facial features;
the at least one processing device is configured to allow the user to select one or more animatable facial features to overlap on the object and to be animated; and
the one or more animatable facial features comprise one or more of: eyes, a mouth, a nose, jaws, or eyebrows.

12. The electronic device of claim 9, wherein the electronic device comprises at least one of: a mobile device, an extended reality (XR) device, or a smart display.

13. The electronic device of claim 9, wherein:
the facial features for the user input image comprise at least eyes and a mouth; and
the landmark points are assigned from at least the eyes and the mouth.

14. The electronic device of claim 9, wherein, to determine the facial features for the user input image, the at least one processing device is configured to:
fit an initial set of ellipses according to the contour lines for the user input image; and
filter the initial set of ellipses by (i) removing one or more of the ellipses that fit within another of the ellipses and (ii) removing one or more ellipses located within a specified region of the user input image and having a size exceeding a specified threshold.

15. The electronic device of claim 9, wherein the at least one processing device is configured to assign the landmark points with an equal distance around the ellipses remaining after the ellipse filtering.

16. The electronic device of claim 9, wherein, to generate the animated avatar, the at least one processing device is configured to:
for each of the audio frames, determine a shape key corresponding to the predicted positions of the landmark points; and
use the shape key to warp the landmark points for the user input image.

17. A non-transitory machine readable medium containing instructions that when executed cause at least one processor of an electronic device to:
receive a user input image for a user;
determine contour lines for the user input image using a first model performing edge detection;
determine facial features for the user input image using ellipse fitting to the contour lines and ellipse filtering to keep only specified ones of the facial features;
assign landmark points for the user input image along ellipses remaining after the ellipse filtering;
receive audio frames comprising speech data;
for each of the audio frames, use a second model to predict positions of the landmark points for the user input image based on audio features in the audio frame; and
generate an animated avatar by warping the landmark points for the user input image based on the predicted positions of the landmark points.

18. The non-transitory machine readable medium of claim 17, wherein:
the user input image comprises an object without facial features;
the instructions when executed cause the at least one processor to allow the user to select one or more animatable facial features to overlap on the object and to be animated; and
the one or more animatable facial features comprise one or more of: eyes, a mouth, a nose, jaws, or eyebrows.

19. The non-transitory machine readable medium of claim 17, wherein the instructions that when executed cause the at least one processor to determine the facial features for the user input image comprise:
instructions that when executed cause the at least one processor to fit an initial set of ellipses according to the contour lines for the user input image; and
instructions that when executed cause the at least one processor to filter the initial set of ellipses by (i) removing one or more of the ellipses that fit within another of the ellipses and (ii) removing one or more ellipses located within a specified region of the user input image and having a size exceeding a specified threshold.

20. The non-transitory machine readable medium of claim 17, wherein the instructions that when executed cause the at least one processor to generate the animated avatar comprise:
instructions that when executed cause the at least one processor, for each of the audio frames, to determine a shape key corresponding to the predicted positions of the landmark points; and
instructions that when executed cause the at least one processor to use the shape key to warp the landmark points for the user input image.
